(19) United States
(12) Patent Application Publication
(10) Pub. No.: US 2015/0032891 A1
(43) Pub. Date: Jan. 29, 2015

(54) Access Control System

(71) Applicant: Keri Systems, Inc., San Jose, CA (US)

(72) Inventor: Kenneth J. Geiszler, Campbell, CA (US)

(73) Assignee: Keri Systems, Inc., San Jose, CA (US)

(21) Appl. No.: 13/950,172

(22) Filed: Jul. 24, 2013

(51) Int. Cl. H04L 12/911

(52) U.S. Cl. CPC H04L 47/70
USPC 709/225

(57) ABSTRACT

An exemplary embodiment of an access control system includes a data communications network, a first access device coupled to the network, a network switching device (switch) configured for operation on the data communications network with one or more access devices. The switch includes at least one processor configured to operate in accordance with firmware instructions, a first memory configured to store the firmware instructions, and a second memory configured to store access information. The firmware instructions are configured to cause the switch to, in response to a communication containing an access request including at least user identification information received from a first access device: make a comparison of the user identification information from the access request with access information stored in the second memory, make an access decision based on the comparison; and transmit the access decision to at least the first access device over the network.

TECHNICAL FIELD

The present disclosure relates generally to access control systems.

### BACKGROUND

As illustrated in FIG. 1, an access control system for a facility 10 such as a building or the like generally includes two types of devices at facility entry points 12. These are (1) devices for obtaining identification information from someone potentially authorized to access the facility 10 (e.g., identification card readers, biometric identification scanners, alpha-numeric key pads, some combination of these, and the like) (collectively referred to as “readers”) 14, and (2) devices which actually control the access (e.g., locks, door opening systems, and the like) (collectively referred to as “locks”) 16. Such access control systems also generally include a dedicated access control computer or computers 18 to keep track of identity information for those authorized access to the facility, process access requests to allowance or denial, and to log the activity (access allowances and denials) of the access control system. The computers have access to an access database 20 either built into the computer or available remotely. Access database 20 stores a current list of valid access credentials. The computers 18 communicate with the readers and locks to provide or deny access when presented with an access request. Common systems in use today utilize various wired systems 22 using data network protocols (e.g., RS-232, RS-422 and RS-485, Wiegand, among others) to connect the readers, locks and computers. Such systems include separate circuits which need to be wired in a facility and add significantly to the cost of construction.

In some access control systems devices located near the readers or locks (or integrated therewith) contain computer processors and replicas of at least portions of the access database 20 so that access decisions may be made locally.

Access control systems 10 may be layered in that in addition to facility access control they may also provide limited access to specific features and/or areas within the facility depending upon the authorization given to a specific user. For example, one individual's access credential may grant the individual access only to the relatively public areas of a facility while another individual's access credential may grant that individual access to every room within the facility.

### OVERVIEW

An exemplary embodiment of an access control system includes a data communications network, a first access device coupled to the network, a network switching device (switch) configured for operation on the data communications network with one or more access devices. The switch includes at least one processor configured to operate in accordance with firmware instructions, a first memory configured to store the firmware instructions, and a second memory configured to store access information. The firmware instructions are configured to cause the switch to, in response to a communication containing an access request including at least user identification information received from a first access device: make a comparison of the user identification information from the access request with access information stored in the second memory, make an access decision based on the comparison; and transmit the access decision to at least the first access device over the network.

### BRIEF DESCRIPTION OF THE DRAWINGS

The accompanying drawings, which are incorporated into and constitute a part of this specification, illustrate one or more exemplary embodiments and, together with the description of the exemplary embodiments, serve to explain the principles and implementations of the invention.

In the drawings:

FIG. 1 is a system block diagram illustrating a facility access control system in accordance with the prior art.

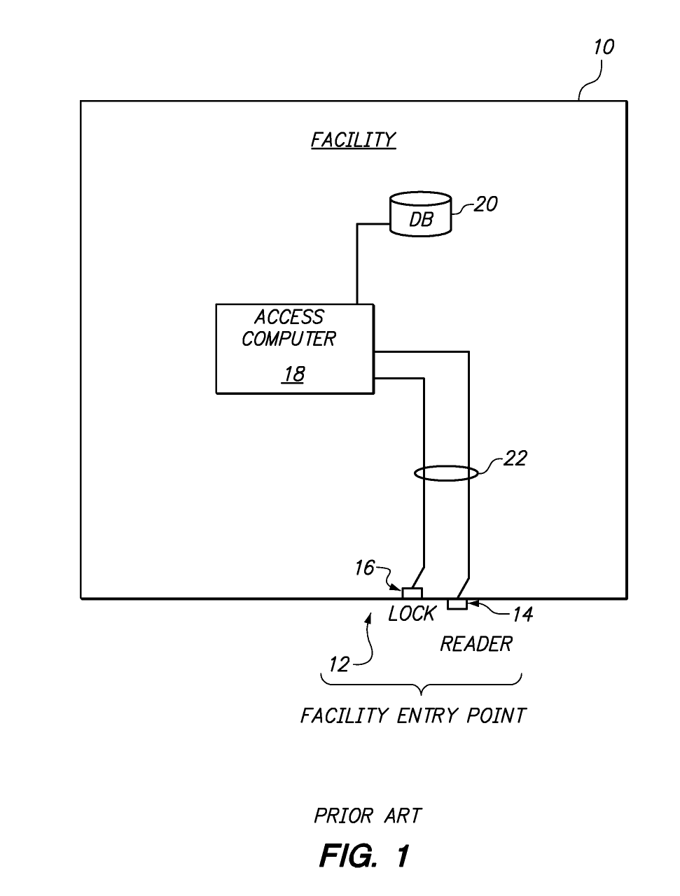

FIG. 2 is a system block diagram illustrating a facility access control system in accordance with one exemplary embodiment.

FIG. 3 is a simplified block diagram of an IP v4 packet header.

FIG. 4 is a process flow diagram of a process used by a network switch device in accordance with one exemplary embodiment.

FIG. 5 is a system block diagram illustrating a portion of an access control system in accordance with one exemplary embodiment.

### DESCRIPTION OF EXAMPLE EMBODIMENTS

Exemplary embodiments are described herein in the context of an access control system. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

References herein to “one embodiment” or “an embodiment” or “one implementation” or “an implementation” means that a particular feature, structure, part, function or characteristic described in connection with an exemplary embodiment can be included in at least one exemplary embodiment. The appearances of phrases such as “in one embodiment” or “in one implementation” in different places within this specification are not necessarily all referring to the same embodiment or implementation, nor are separate and alternative embodiments necessarily mutually exclusive of other embodiments.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

A data communications network switch device such as an Ethernet switch, router, hub or the like, is essentially a computer operating under the control of firmware instructions stored in a memory on board the network device and carrying out those instructions in order to route data packets from input ports to output ports in a predetermined manner. The hardware of such network devices is usually designed to render decisions regarding the routing of data rapidly, generally by use of specialized port ASICs and fast limited purpose computer processors. Packets are received by the network device, stored temporarily in a memory of the network device, then transmitted or otherwise acted on by the network device.

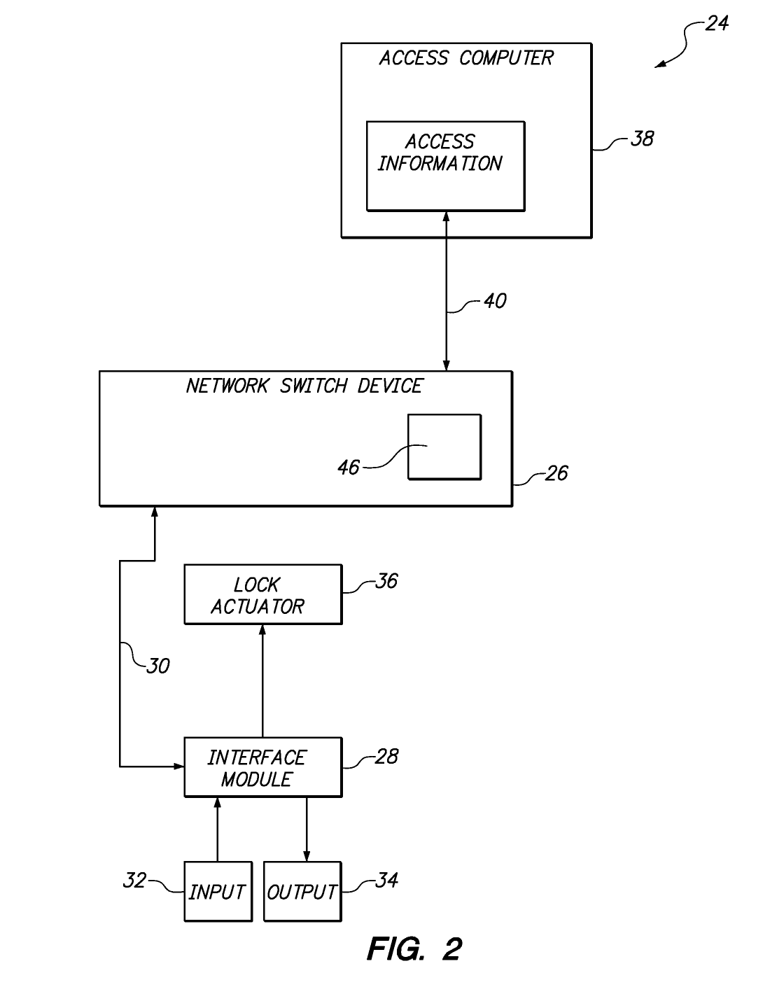

FIG. 2 is a system block diagram illustrating a facility access control system 24 in accordance with one exemplary embodiment. In accordance with this embodiment a network switch device 26 such as an Ethernet switch, router, hub or the like is provided with additional functionality by adding code to its firmware. The additional functionality allows it to process data communication packet traffic received from an interface module 28 over a first wired or wireless data communications path 30 so that the switch device 26 can immediately respond to the interface module with an access control decision over the data communications network. In the exemplary embodiment illustrated in FIG. 2 interface module 28 is an electronic device with data communications network communications capability (such as an Ethernet card) which is coupled to input user interface equipment 32, output user interface equipment 34 and a lock actuator 36. In one example the input user interface equipment may include an access credential reader such as a proximity RFiD card reader, a mag-stripe card reader, a smartcard reader or the like, and may optionally be combined with one or more biometric input devices such as cameras, keypads, fingerprint readers, and the like. The lock actuator 36 controls the state of a lock or other access device which controls access to the facility. For example it may be a simple solenoid which when activated pulls back a door latch allowing a door to be opened. Alternatively it may be a turnstile-type access control device, an elevator control system which allows access to one or more floors if the access credential is so authorized, or the like. It will now be apparent to those of ordinary skill in the art that many other types of access control systems may be controlled in this manner.

In order to use the system of FIG. 2, a user presents an access credential to the input user interface equipment 32 and, if required, enters additional information through any biometric devices (cameras, fingerprint readers, cameras or the like) present. The completion of this action generates an access request packet transmission to an access computer 38 over second wired or wireless data communication path 40 which includes at one end the switch device 26. The switch device 26 recognizes the packet as an access request packet and in addition to passing the packet to its destination at the access computer 38 for logging purposes, it acts on the request if it can. In so doing switch device 26 sends an access response packet back to interface module 28 (as well as optionally to the access computer for logging purposes) either permitting or denying the requested access. In the case of access being permitted, the lock actuator 36 or other access control device is placed into a state allowing the user to enter the facility and output user interface equipment 34 is optionally set to indicate that access is allowed, e.g., via a visually perceivable signal, an audible signal, or the like. In the case of access being denied, the lock actuator 36 or other access control device remains in a state denying access to the facility and output user interface equipment 34 is optionally set to indicate that access is denied, e.g., via a visually perceivable signal, an audible signal, no signal, or the like. Where the access request cannot for some reason be handled by the network device 26, e.g., where special biometric or other identification processing is required that requires action by another computing device, or by a human, the access request may be passed along to that other computing device or human for further action.

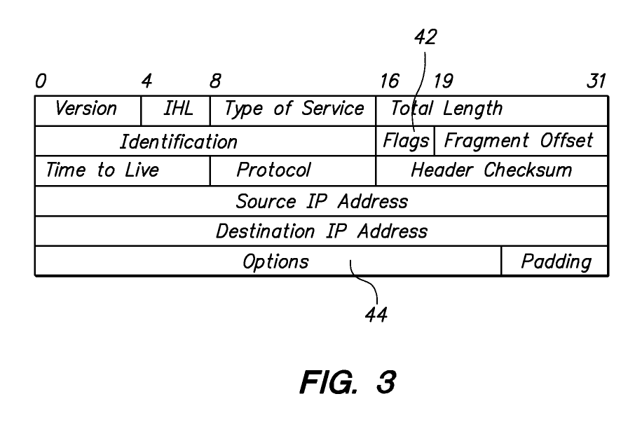

FIG. 3 is a simplified block diagram of an IPv4 (Internet Packet Protocol Version 4) packet header. While the invention is not intended to be limited to any particular type of data communications protocol, the IPv4 packet is used here as an explanatory tool. In the header of the conventional IPv4 packet there are a number of flags 42 and options 44 (among other settable data) that may be set to specify a particular type of packet. Access control packets may be specified by a particular value in one or more of these fields of the packet header (or elsewhere in the packet) so that they may be readily identified by the network switch device 26.

Conventional network switch devices 26 operate generally as follows. A data packet is received on an input port. The packet is inspected to determine its type, quality of service applicable, destination address, possibly other criteria, and based on this information the packet is queued for transmission on an output port of the network switch device 26. In the case of a network switch device 26 in accordance with an exemplary embodiment, the inspection will include (at least for packets arriving on input ports which include interface modules) a check to determine if the packet is an access request packet. The network switch device 26 includes an onboard memory store 46 for storing periodically updated valid access credentials. Thus when an access request packet is detected a comparison of the credential with the database may be conducted immediately onboard switch device 26 without waiting to send a request to a remote database and receive a response. In response to the comparison the switch device 26 will respond immediately sending the packet to the various recipients required (e.g., the access computer 38 for logging purposes, the interface module 28 for access purposes).

The on board memory store 46 of switch device 26 will generally be periodically updated with current access information from access computer 38 or from another source of up-to-date access information. This may be done, for example, by sending a packet to switch device 26 with an appropriate header so that it may determine that the packet is for the purpose of updating on board memory store 46 and thereby causing switch device 26 to update the access information within memory store 46 accordingly.

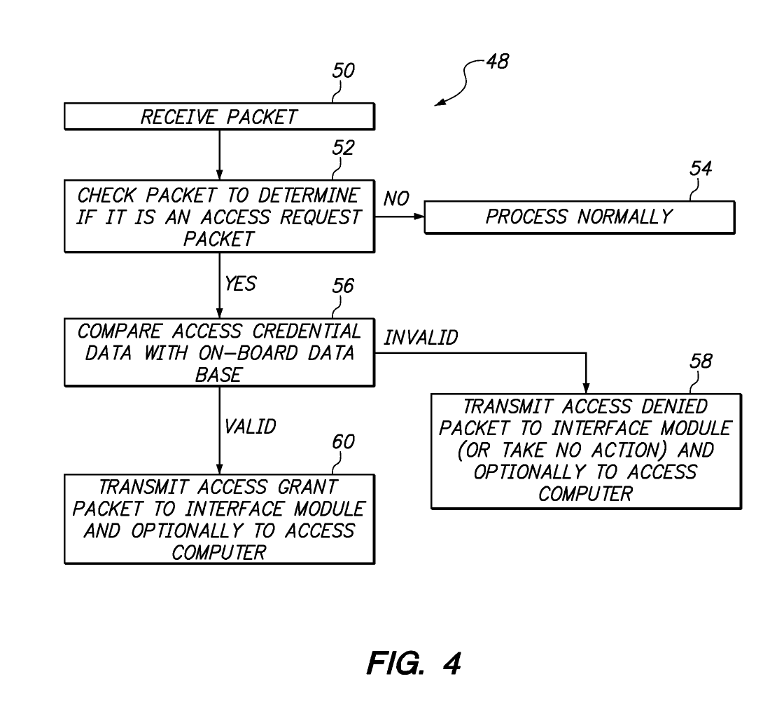

FIG. 4 is a process flow diagram of a process 48 used by a network switch device in accordance with one exemplary embodiment. At Step 50 a packet is received by switch device 26. The packet may be received on a port dedicated to receiving packets from one or more access control devices.

At Step 52 switch device 26 checks the packet to determine if it is an access request packet. This check may be performed in a number of ways. First, a special indication within the packet (such as within the header) may be used. Second, the presence of the packet on a dedicated physical port of the switch device 26 may be used. Third, a logical address or port specified within the packet may be used. Fourth, some combination of the previous methods may be used. If it is determined that the packet is NOT an access request packet, control proceeds to Step 54 where the packet is processed normally. If it is determined that the packet IS an access request packet, control proceeds to Step 56.

At Step 56 the packet has been determined to be an access request packet. The switch device 26 compares the access request packet user identification information with the information stored in the on board memory store 46 and if it does not match or if additional processing is required then control passes to Step 58. If it does match control passes to Step 60.

At Step 58 switch device 26 transmits a packet to interface module 28 (and optionally to access computer 38) indicating that access is not to be granted. The instruction to interface module 28 can be to take no action, to indicate that no access is allowed via output 34, or to wait until the access request packet can be additionally processed by the access computer 38 (as where some sort of biometric data needs to be processed in addition to a simple logical identification).

At Step 60 switch device 26 transmits a packet to interface module 28 (and optionally to access computer 38) indicating that access is to be granted. In this case the instruction to interface module 28 would generally be to indicate access via output 34 and to actuate the lock actuator 36 so as to allow access to the user.

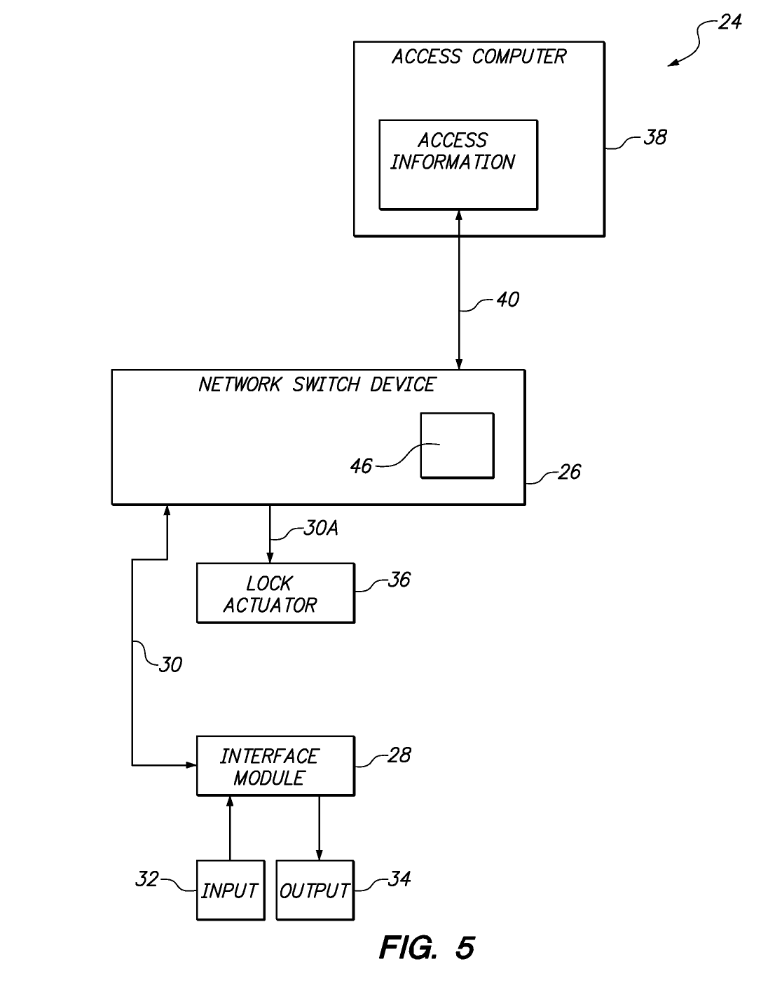

FIG. 5 is a system block diagram illustrating a portion of an access control system in accordance with one exemplary embodiment. In accordance with the exemplary embodiment illustrated in FIG. 5, the lock actuator 36 is provided with a third wired or wireless data communications path 30A which allows it to communicate with switch device 26 independently of interface module 28. In this exemplary embodiment instructions to actuate the lock actuator 36 would be sent directly to lock actuator 36 rather than to interface module 28.

While exemplary embodiments and applications have been shown and described, it would be apparent to those skilled in the art having the benefit of this disclosure that numerous modifications, variations and adaptations not specifically mentioned above may be made to the various exemplary embodiments described herein without departing from the scope of the invention which is defined by the appended claims.

What is claimed is:

1. A network switching device configured for operation on a data communications network with one or more access devices, the network switching device comprising:
at least one processor configured to operate in accordance with firmware instructions;
a first memory configured to store the firmware instructions;
a second memory configured to store access information;
the firmware instructions configured to cause the network switching device to, in response to a communication containing an access request including at least user identification information received from a first access device:
make a comparison of the user identification information from the access request with access information stored in the second memory;
make an access decision based on the comparison; and
transmit the access decision to at least the first access device.

2. The network switching device of claim 1, wherein the at least one processor is further configured to:
periodically update the access information stored in the second memory with updated information received over the network.

3. The network switching device of claim 1, wherein the at least one processor is further configured to:
transmit the access decision to a record-keeping device.

4. The network switching device of claim 1, wherein the at least one processor is further configured to:
transmit the access decision to a second access device.

5. An access control system comprising:
a data communications network;
a first access device coupled to the network;
a network switching device configured for operation on the data communications network with one or more access devices, the network switching device including:
at least one processor configured to operate in accordance with firmware instructions;
a first memory configured to store the firmware instructions;
a second memory configured to store access information;
the firmware instructions configured to cause the network switching device to, in response to a communication containing an access request including at least user identification information received from a first access device:
make a comparison of the user identification information from the access request with access information stored in the second memory;
make an access decision based on the comparison; and
transmit the access decision to at least the first access device over the network.

6. The system of claim 5, wherein the at least one processor is further configured to:
update the access information stored in the second memory with updated information received over the network.

7. The system of claim 5, further comprising:
a record-keeping device coupled to the network; and
wherein the at least one processor is further configured to:
transmit the access decision to the record-keeping device.

8. The system of claim 5, further comprising:
a second access device; and
wherein the at least one processor is further configured to:
transmit the access decision to a second access device.

9. A method for controlling access to a facility, the method comprising:
providing a data communications network associated with the facility;
providing a first access device coupled to the network;
providing a network switching device configured for operation on the network with one or more access devices, the network switching device including:
at least one processor configured to operate in accordance with firmware instructions;
a first memory configured to store the firmware instructions;
a second memory configured to store access information;
receiving at the network switching device a communication containing an access request including at least user identification information received from the first access device;
making a comparison of the user identification information from the access request with access information stored in the second memory;
making an access decision based on the comparison; and
transmitting the access decision to at least the first access device over the network.

10. The method of claim 9, further comprising:
updating the access information stored in the second memory with updated information received over the network.

11. The method of claim 9, further comprising:
transmitting the access decision to a record-keeping device coupled to the network.

12. The method of claim 9, further comprising:
transmitting the access decision to a second access device coupled to the network.

13. A method comprising:
at a network switching device,
examining a packet stored in a first memory of the device,
responsive to the examining, determining whether the packet is an access request packet containing an access request,
responsive to determining that the packet is an access request packet, using identification information from the packet to access information stored in a second memory of the device and determining if the access request is allowable, and
responsive to determining that the access request is allowable, transmitting a packet indicating that the access request is allowed to at least a lock actuator.
